(19) United States
(12) Patent Application Publication
(10) Pub. No.: US 2006/0089123 A1
(43) Pub. Date: Apr. 27, 2006

(54) Use of information on smartcards for authentication and encryption

(76) Inventor: Edward H. Frank, Atherton, CA (US)

Correspondence Address: CHRISTIE, PARKER & HALE, LLP, PO BOX 7068, PASADENA, CA, 91109-7068, US

(21) Appl. No.: 11/168,180

(22) Filed: Jun. 27, 2005

Related U.S. Application Data
(60) Provisional application No. 60/621,238, filed on Oct. 22, 2004.

(51) Int. Cl. H04M 1/66

(52) U.S. Cl. 455/411

(57) ABSTRACT

Methods and systems are provided that use information on smartcards, such subscriber identity module (SIM) cards for authentication and encryption. One embodiment of the invention provides a mobile communication network architecture that includes a mobile network, a mobile terminal, a server coupled to the mobile terminal via the mobile network, and a SIM card coupled to the mobile terminal. The SIM card includes a first key and a second key. The first key is used to authenticate an intended user of the mobile terminal to the mobile network and the second key is used to authenticate the intended user to the server.

### CROSS-REFERENCE TO RELATED APPLICATIONS(S)

This application claims priority to and the benefit of U.S. Provisional Application No. 60/621,238, filed Oct. 22, 2004, the entire content of which is incorporated herein by reference.

### FIELD OF THE INVENTION

The invention relates generally to the field of data communications and, more particularly, to systems and methods for providing secured data transmission using smartcards, such as subscriber identity module (SIM) cards.

### BACKGROUND OF THE INVENTION

Currently, cables and wires are predominately used in communication networks for transferring information such as voice, video, data, etc. from one device to another. Devices on a communication network can generally be categorized as two types: servers and clients. Those devices that provide services to other devices are servers; the devices that connect to and utilize the provided services are clients. Generally in a wired network, authentication of a user for accessing a wired network, such as a local area network (LAN), can require the user to sign-on by providing information such as a login identification and a password on a client. And because each client within the wired network is physically connected to the network and can have a unique address, a communication session between a server on the wired network and the client is generally secure.

However, there is a growing desire to have network clients be portable or to have a mobile client that can operate beyond a defined environment. In contrast to wired clients, wireless or mobile clients can establish a communication session with a server without being physically connected to cables or wires. Accordingly, information such as voice, video, and data are transmitted and received wirelessly from one device to another and the information can be intercepted or tampered with by an impersonator posing as an intended user. Therefore, one way to ensure security within a mobile communication network would be to provide a system and method that can authenticate and identify the intended user to the mobile communication network supplying the services.

In addition, as the development of mobile communication network technology continues to advance, various services offered through the mobile communication network have also advanced. These advanced services, for example, financial data services, may require a higher level of data security. Thus, there is also a need to provide an additional level or levels of protection for these advance services to an intended user that goes beyond authenticating the intended user to the mobile communication network that is supplying the services.

### SUMMARY OF THE INVENTION

The invention relates to systems and associated methods for providing secured data transmission using smartcards, such as subscriber identity module (SIM) cards (but not exclusively). For example, a mobile network architecture constructed according to the invention provides secure provision and storage of keys and provides decryption and encryption of data that is transmitted over a mobile network with an additional level or levels of protection.

One embodiment of the invention provides a mobile communication network architecture for authentication. The network architecture includes a mobile network, a mobile terminal, a server coupled to the mobile terminal via the mobile network, and a smartcard coupled to the mobile terminal. The smartcard includes a first key and a second key. The first key is used to authenticate an intended user of the mobile terminal to the mobile network and the second key is used to authenticate the intended user to the server.

In addition and/or in an alternative, the second key and/or a third key (included in the smartcard) may be used to authenticate the intended user to a specific service (e.g., out of one or more services) provided by the server and/or another server. Moreover, the smartcard may include one or more encryption keys for encrypting and decrypting the data transmitted between the mobile terminal and the mobile network and/or between the mobile terminal and the server.

The keys on a smartcard used in a mobile communication network architecture of the invention may be provided through a key writing or burning site (e.g., a music retailer, a mobile phone retailer, etc). The key writing or burning site may be connected to an authentication server (and/or another server) via a network (e.g., the Internet) so that a new authentication key or keys can be written and/or burned into the smartcard. In one embodiment, the key writing or burning site allows an intended user to purchase a desired service and burns and/or writes a key into the smartcard to authenticate the user to the desired service and/or a server providing the desired service upon the purchase of the service.

One embodiment of the invention provides a method for using information on a smartcard for authentication and encryption. The method includes transmitting a random number to a mobile client from within a mobile network. The mobile client computes a signed response based on the random number sent to the mobile client with an authentication algorithm using a first authentication key. Upon receiving the signed response from the mobile client, the mobile network repeats the calculation to verify the identity of an intended user. If the values do not match, the connection to the mobile network is terminated. If the signed response received by the mobile network agrees with the calculated value, a second random number is sent to the mobile client from an authentication server that is not part of the mobile network. The mobile client computes a second signed response based on the random number sent to the mobile client with a second authentication algorithm using a second authentication key. Upon receiving the signed response from the mobile client, the authentication server repeats the calculation to verify the identity of the intended user to a server (e.g., a financial data server) associated with the authentication server. If the signed response received by the network agrees with the calculated value, the mobile client has been successfully authenticated and access to the server (e.g., the financial data server) is granted. If the values do not match, the connection to the authentication server is terminated.

A third authentication key may also be used to authenticate the intended user to a specific service offered by the server. Moreover, one or more encryption keys may be used to encrypt and decrypt the data transmitted between the mobile client and the mobile network and/or between the mobile client and the server.

A more complete understanding of the use of information on smartcards for authentication and encryption will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is a schematic diagram of a mobile communication network architecture pursuant to aspects of the invention;

FIG. 2 is a more detailed schematic diagram of a mobile client of FIG. 1;

FIG. 3 is a more detailed schematic diagram of a switching center of FIG. 1;

FIG. 4 is a schematic diagram of another mobile communication network architecture pursuant to aspects of the invention;

FIG. 5 is a more detailed schematic diagram of a mobile client of FIG. 4;

FIG. 6 is a schematic diagram of a further mobile communication network architecture pursuant to aspects of the invention;

FIG. 7 is a schematic diagram of a data server and an authentication server pursuant to aspects of the invention;

FIG. 8 is a schematic diagram of yet another mobile communication network architecture pursuant to aspects of the invention;

FIG. 9 is a schematic diagram of a system and method for providing keys to a subscriber identity module (SIM) card pursuant to aspects of the invention;

FIG. 10 is a flowchart representative of one embodiment of operations pursuant to aspects of the invention;

FIG. 11 is a schematic diagram of an embodiment of a key management system that incorporates stateless key management modules (or stateless modules) pursuant to aspects of the invention; and

FIG. 12 is a schematic diagram of a key transfer embodiment between a stateless module and a smartcard pursuant to aspects of the invention.

### DETAILED DESCRIPTION OF THE INVENTION

The invention is described below, with reference to detailed illustrative embodiments. It will be apparent that the invention can be embodied in a wide variety of forms, some of which may be quite different from those of the disclosed embodiments. Consequently, the specific structural and functional details disclosed herein are merely representative and do not limit the scope of the invention.

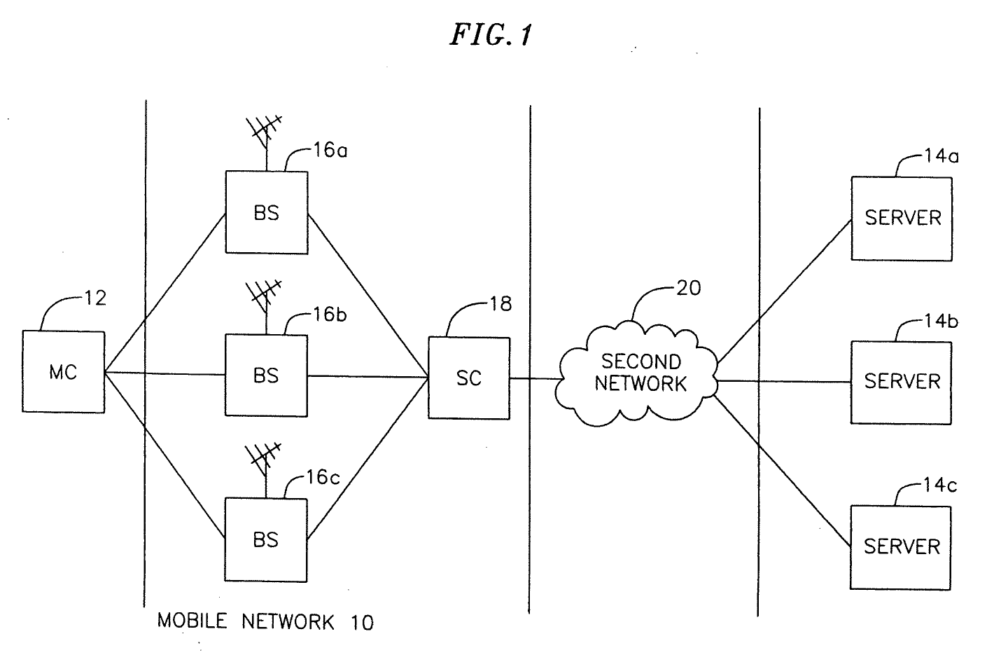

FIG. 1 is a block diagram of a mobile communication network architecture that uses a smartcard for authentication and/or encryption. Exemplary embodiments of the present invention can be applied to the network architecture of FIG. 1, as well as other suitable architectures.

The network architecture of FIG. 1 includes mobile network 10 that facilitates communications between one or more mobile clients, such as mobile client 12, and one or more servers 14 (e.g., 14a, 14b, and/or 14c). Mobile network 10 may be a wireless communications system that supports the Global System for Mobile Communications (GSM) protocol. However, other multi-access wireless communications protocol, such as General Packet Radio Services (GPRS), High Data Rate (HDR), Wideband Code Division Multiple Access (WCDMA) and/or Enhanced Data Rates for GSM Evolution (EDGE), may also be supported. Mobile client 12 may be any device that is adapted for wireless communications with mobile network 10, such as a cellular telephone, pager, personal digital assistant (PDA), vehicle navigation system, and/or portable computer.

Mobile network 10 includes one or more base stations 16 (e.g., 16a, 16b, and/or 16c) and switching center 18. Mobile network 10 connects mobile client 12 to servers 14a, 14b, and/or 14c either directly (not shown) and/or through second network 20, such as a Public Switched Telephone Network (PSTN), an Integrated Services Digital Network (ISDN), a Packet Switched Public Data Network (PSPDN), a Circuit Switched Public Data Network (CSPDN), a local area network (LAN), the Internet, etc. Mobile network 10 is operated by a carrier that has an established relationship with an intended user (or subscriber) of mobile client 12 to use the wireless services provided through mobile network 10.

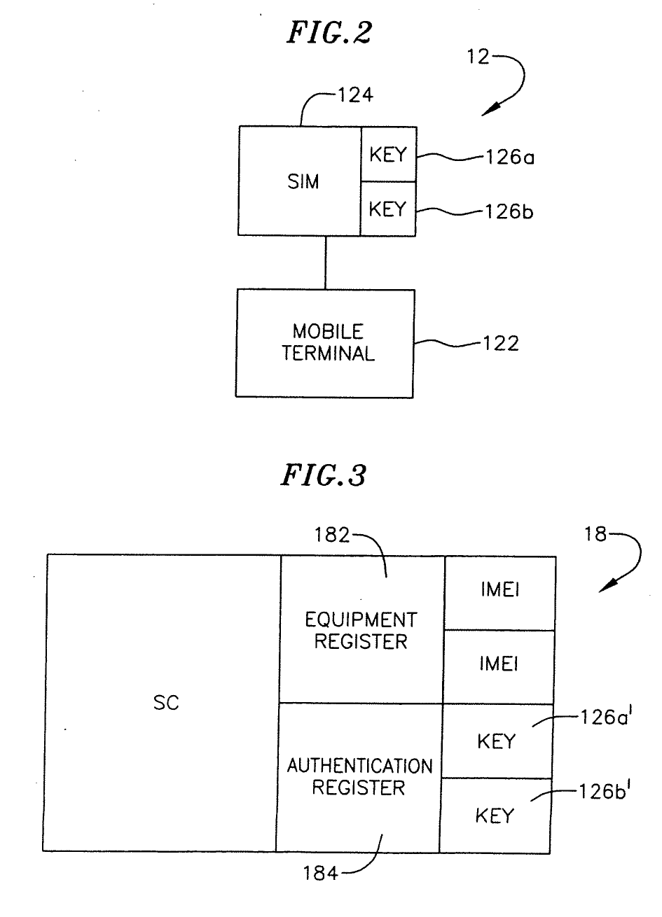

Referring now to FIG. 2, mobile client 12 includes mobile terminal 122 (e.g., a mobile equipment or a phone) and smartcard 124. More specifically, smartcard 124 of FIG. 2 is a Subscriber Identity Module (SIM). SIM (or SIM card) 124 contains encryption key 126a that encrypts voice and data transmissions to and from mobile network 10 and authentication key 126b that specifies an intended user so that the intended user can be identified and authenticated to mobile network 10 supplying the mobile services. SIM 124 can be moved from one mobile terminal 122 to another terminal (not shown) and/or different SIMs can be inserted into any terminal, such as a GSM compliant terminal (e.g., a GSM phone).

To provide additional security, mobile terminal 122 may include an International Mobile Equipment Identity (IMEI) that uniquely identifies mobile terminal 122 to network 10. SIM card 124 may be further protected against unauthorized use by a password or personal identity number.

Referring now back to FIG. 1, each base station 16a, 16b, 16c includes a radio transceiver that defines a cell and handles the radio-link protocols with mobile client 12. A base station controller (now shown) may also be coupled between one or more base stations 16a, 16b, 16c and switching center 18 to manage the radio resources for one or more base stations 16a, 16b, 16c. The base station controller may handle radio-channel setup, frequency hopping, and handovers (e.g., as the mobile client moves from one base station coverage area or cell to another).

The central component of mobile network 10 is switching center 18. Switching center 18 acts like a normal switching node, such as a switching node in a PSTN or ISDN, and additionally provides all the functionality needed to handle a mobile user (subscriber), such as registration, authentication, location updating, handovers, and call routing to a roaming subscriber. In FIG. 1, it is switching center 18 that provides the connection of mobile client 12 to second network 20 (such as the LAN, the PSTN, the ISDN etc).

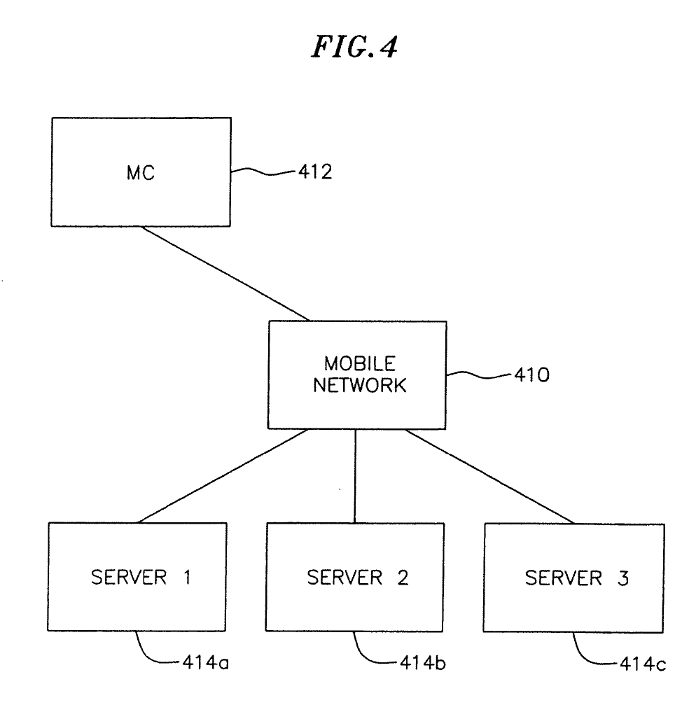

Referring now to FIG. 3, switching center 18 includes equipment identity register 182 and authentication register 184. Identity register 182 includes a database that contains a list of all valid mobile terminals (e.g., 122 of FIG. 2) on network 10, where each mobile client (e.g., 12) is identified by its International Mobile Equipment Identity (IMEI). An IMEI is marked as invalid if it has been reported stolen or is not type approved. Authentication register 184 is a protected database that stores copies 126a′, 126b′ of the secret keys (e.g., 126a, 126b) stored in each intended user's (or subscriber's) SIM card (e.g., 124), which are used for authentication of an intended user and encryption/description of data transmitted over a radio channel of mobile network 10.

Specifically, referring now also to FIGS. 1 and 2, mobile network 10 can be a GSM compliant network that authenticates the identity of an intended user through the use of a challenge-response mechanism. A 128-bit random number is sent to mobile client 12 from mobile network 10. Mobile client 12 computes a 32-bit signed response based on the random number sent to mobile client 12 with an authentication algorithm using individual subscriber authentication key 126b. Upon receiving the signed response from mobile client 12, mobile network 10 repeats the calculation to verify the identity of the user. Note that individual subscriber authentication key 126b is not transmitted over the radio channel. It should only be present in SIM card 124, as well as authentication register 184. If the signed response received by network 10 agrees with the calculated value, mobile client 12 has been successfully authenticated and may continue. If the values do not match, the connection to network 10 is terminated.

In addition, SIM card 124 of FIGS. 1, 2, and 3 contains encryption key 126a. Encryption key 126a is used to encrypt and decrypt the data transmitted between mobile client 12 and mobile network 10. The encryption of the voice and data communications between mobile client 12 and network 10 is accomplished through use of an encryption algorithm. An encrypted communication is initiated by an encryption request command from mobile network 10. Upon receipt of this command, mobile client 12 begins encryption and decryption of data using the encryption algorithm and the encryption key 126a.

As envisioned, an embodiment of the present invention provides an additional level and/or levels of protection using a SIM card that goes beyond authenticating an intended user to a mobile communication network and encrypting/decrypting data to and from the network.

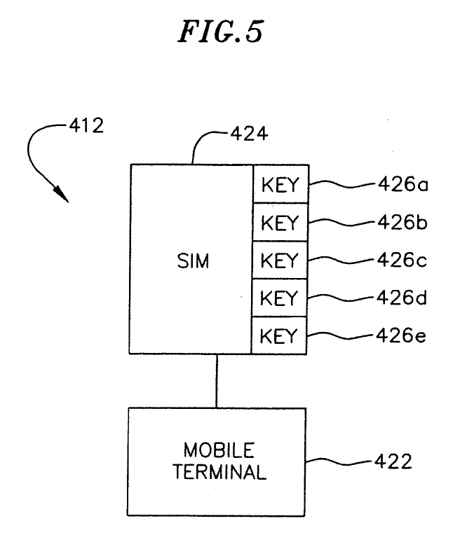

Referring to FIG. 4, a mobile communication network architecture pursuant to the present invention includes mobile network 410 that facilitates communications between one or more mobile clients, such as mobile client 412, and one or more servers 414a, 414b, 414c. Mobile network 410 may be a wireless communications network similar to the mobile network of FIG. 1, as well as other suitable networks.

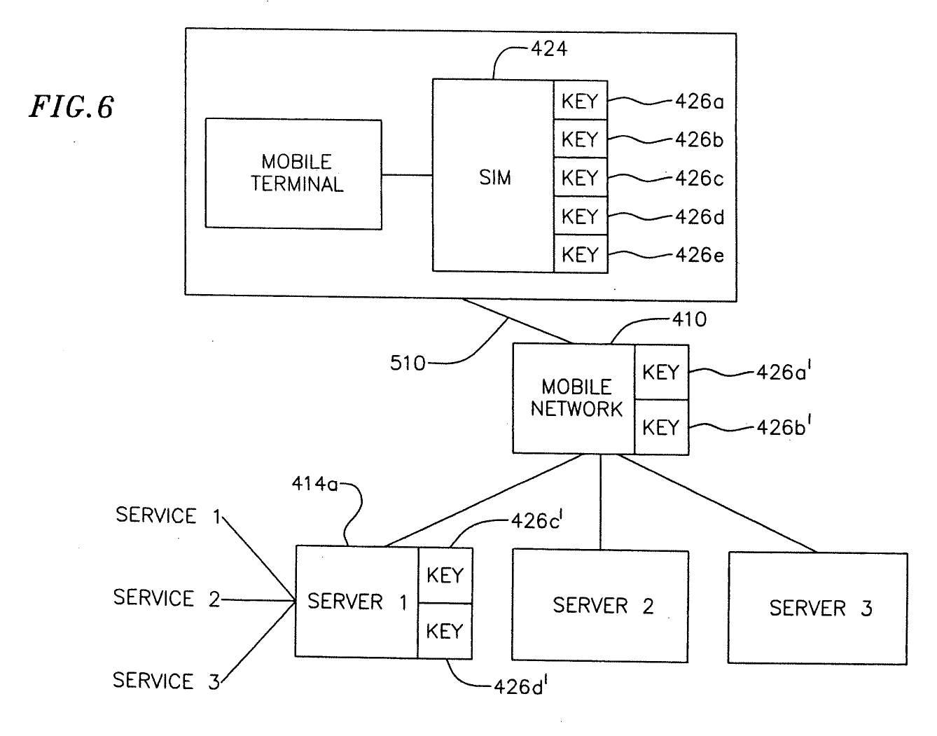

Referring now to FIG. 5, mobile client 412 includes mobile terminal 422 (e.g., a phone, a PDA, etc.) and Subscriber Identity Module (SIM) 424. SIM (or SIM card) 424 contains encryption key 426a that encrypts voice and data transmissions to and from the mobile network 410 and authentication key 426b that specifies an intended user so that the intended user can be identified and authenticated to mobile network 410. In addition, SIM 424 includes one or more additional keys 426c, 426d, 426e to provide an additional level or levels of protection that goes beyond merely authenticating an intended user to mobile communication network 410 and encrypting/decrypting the transmitted data between network 410 and mobile client 412.

In particular, referring now to FIG. 6, mobile network 410 of FIG. 4 includes copies 426a′, 426b′ of the secret keys (e.g., 426a, 426b) stored in SIM card 424. Keys 426a, 426b, 426a′, and 426b′ are used for authenticating the intended user of SIM card 424 to mobile network 410 and encryption/decryption of data transmitted between mobile network 410 and mobile client 412 via communication link 510. Copies 426a′, 426b′ of the secret keys may be stored in an authentication register (e.g., register 184 of FIG. 3) and be managed by a switching center (e.g., switching center 18). In addition, to provide an additional level or levels of protection, SIM (or SIM card) 424 contains second encryption key 426c that encrypts voice and data transmissions to and from one or more servers, such as server 414a, and second authentication key 426d that identifies and authenticates the intended user to (or only to) server 414a supplying the voice and data requested by the intended user.

In FIG. 6, server 414a (e.g., an authentication server of the server 414a) includes copies 426c′, 426d′ of second keys 426c, 426d to authenticate the intended user to server 414a and encrypt/decrypt data transmitted between server 414a and mobile client 412. In addition, copies 426c′, 426′ of the second keys (and/or another key) in server 414a (and/or another server) may be used to revoke (or erase) second key 426c and/or second key 426d in SIM card 424. In one embodiment, second keys 426c, 426d (or another key) in SIM card 424 may be revoked wirelessly via mobile network 410.

Server 414a of FIG. 6 may be a data server that provides highly sensitive financial data services to mobile client 412. However, server 414a may also be an application server, a function providing server and/or another server and may provide other services requiring a high level of protection, such as personnel services, payment services, ordering services, e-mail services, music services, etc. In addition, these services may not be tied to a specific computer or server and may be distributed over one or more traditional computers or servers. One or more servers 414 may provide one or more services, or a service may be implemented by one or more servers 414. Moreover, servers 414 may provide data, applications, and/or functions that come from outside of servers 414, such as data from the Internet.

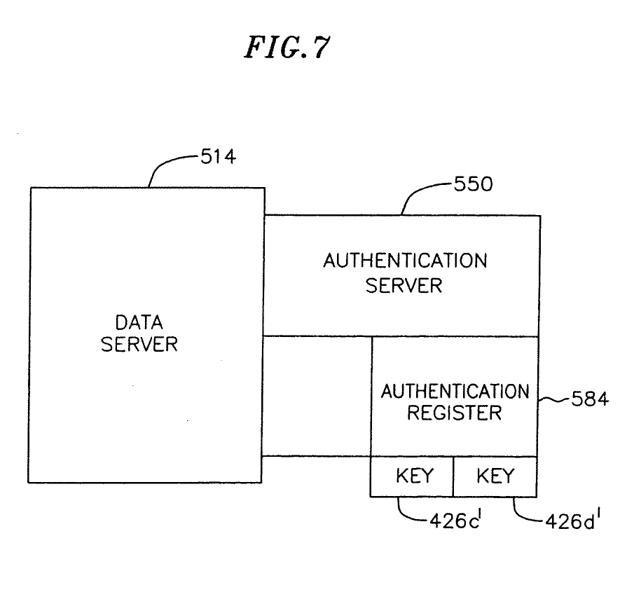

Specifically and referring now to FIG. 7, data server 514 includes (or is coupled to) authentication server 550. Authentication server 550 is a server facility used for ensuring legitimacy of a user and/or for associating the legitimate (or intended) user to its desired data service on data server 514.

Authentication server 550 includes server authentication register 584. Server authentication register 584 is a protected database of authentication server 550 that stores copies 426c′, 426d′ of the secret keys (e.g., keys 26c, 426d of FIG. 6) stored in a SIM card (e.g., SIM 424). Using the copies of the secret keys, authentication server 550 can be used to authenticate an intended user to a particular server (e.g., server 414a) from a plurality of servers (e.g., servers 414a, 414b, 414c) and/or to a particular service from a plurality of services running on one or more of the servers (e.g., servers 414a, 414b, 414c). In addition, authentication server 550 or another server can use the copy of the secret keys to encrypt/decrypt the data transmitted between the server (e.g., server 414a) and the mobile client (e.g., mobile client 412). Further, authentication server 550 (and/or another server) may be used to revoke one or more of the secret keys on the SIM card using copies 426c′, 426d′ of the secret keys and/or another key of authentication server 550.

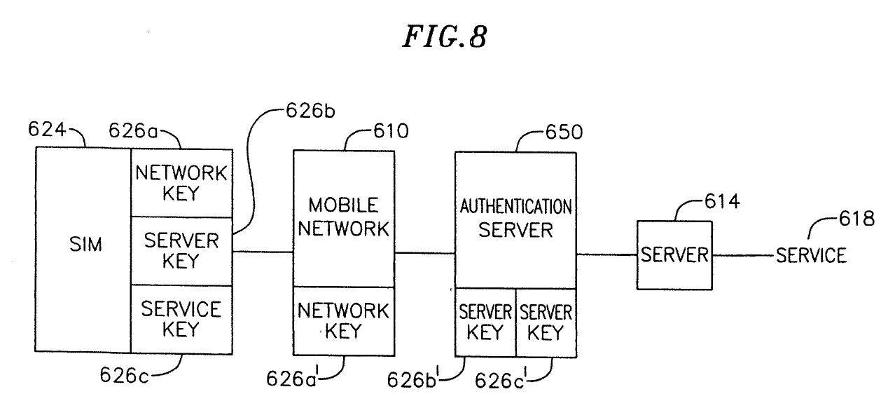

Moreover, to provide additional protection, a SIM card may include a plurality of keys (e.g., the yet another key 426e shown in FIG. 6) in which one of the keys is used for authenticating an intended user to a server and another key is used for authenticating the intended user to the specific service requested by the intended user. For example, FIG. 8 shows SIM card 624 that includes first key 626a, second key 626b, and third key 626c. Mobile network 610 includes copy 626a′ of first key 626a to authenticate an intended user to mobile network 610. Authentication server 650 includes copy 626b′ of second key 626b to authenticate the intended user to server 614 (e.g., a data server) and copy 626c′ of third key 626c to authenticate the intended user to service 618 of server 614.

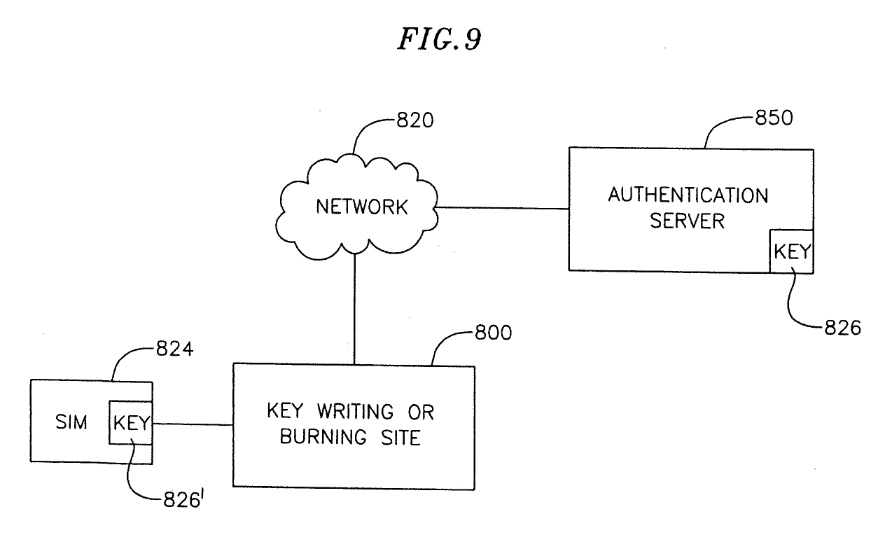

Referring to FIG. 9, an embodiment for providing keys to SIM card 824 of an intended user pursuant to the present invention is shown. The embodiment includes key writing or burning site 800 (e.g., a music retailer, a mobile phone retailer, etc). Key writing or burning site 800 may be connected to authentication server 850 (and/or another server) via network 820 (e.g., the Internet) so that copy 826′ of new authentication key (or keys) 826 can be written and/or burned into SIM card 824. Key writing or burning site 800 can be made accessible to the intended user at a time when SIM card 824 is purchased, at a time when the intended user desires to receive a service offered by a server (e.g., a music data server, a financial data server, a music player application server, etc.) associated with the authentication server, and/or any other time. Specifically, in one embodiment, key writing or burning site 800 allows the intended user to purchase a desired service and burns and/or writes authentication key 826′ into SIM card 824 to authenticate the user to the desired service and/or a server providing the desired service upon the purchase of the service.

In addition, key writing or burning site 800 may be connected to SIM card 824 via a mobile network (e.g., network 10, 410, and/or 610) and then wirelessly burns and/or writes copy 826′ of new authentication key 826 into SIM card 824. Further, authentication key 826 (and/or another key) in authentication server 850 may be used to later revoke (or erase) copy 826′ of key 826 written into SIM card 824. In one embodiment, copy 826′ of key 826 may be revoked wirelessly (e.g., via the mobile network that was used to write copy 826′ of key 826 into SIM card 824).

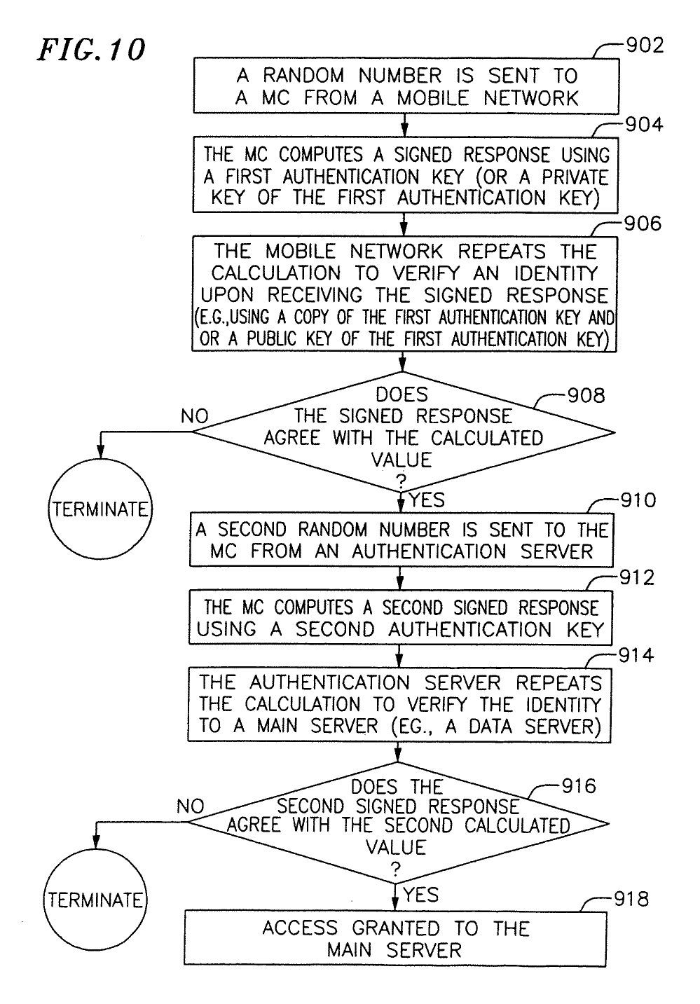

In general, according to the foregoing, the invention provides a method for using information on a SIM card for authentication and encryption, as diagramed in FIG. 10. At block 902, a random number (e.g., a 128-bit number) is sent to a mobile client (MC) from within a mobile network. At block 904, the mobile client computes a signed response (e.g., a 32-bit response) based on the random number sent to the mobile client with an authentication algorithm using a first authentication key. At block 906, upon receiving the signed response from the mobile client, the mobile network repeats the calculation to verify the identity of an intended user. At block 908, if the signed response received by the network agrees with the calculated value, the mobile client has been successfully authenticated and moves to block 910. If the values do not match, the connection to the network is terminated.

At block 910, a second random number (e.g., a second 128-bit number) is sent to the mobile client from an authentication server that is not part of the mobile network. At block 912, the mobile client computes a second signed response (e.g., a second 32-bit response) based on the random number sent to the mobile client with a second authentication algorithm using a second authentication key. At block 914, upon receiving the signed response from the mobile client, the authentication server repeats the calculation to verify the identity of the intended user to a main server (e.g., a financial data server) associated with the authentication server. At block 916, if the signed response received by the network agrees with the calculated value, the mobile client has been successfully authenticated and moves to block 918 to access the main server. If the values do not match, the connection to the authentication server is terminated.

In addition, and/or in an alternative to the above described method, the second authentication key and/or a third authentication key may be used to authenticate the intended user to a specific service offered by the main server and/or another server. The authentication server and/or another server may be used to remotely revoke the second authentication key and/or another key (e.g., the first authentication key).

Moreover, one or more encryption keys may be included on the SIM card and used to encrypt and decrypt the data communicated between the mobile client and the mobile network and/or between the mobile client and the main server. As an example, encryption of the voice and data communications can be accomplished through use of an encryption algorithm. An encrypted communication is initiated by an encryption request command. Upon receipt of this command, the mobile client begins encryption and decryption of data using the encryption algorithm and one or more of the encryption keys.

Lastly, an authentication and/or encryption key of the SIM card may have a private key and a related but different public key, a copy of which is made available outside the SIM card. A challenge may then be supplied to the SIM card and a response is generated using only the private key. The response may be checked by the use of the related public key. Thus, if the private key is held only within the SIM card then only the SIM card can generate an authentication response that would work with the public key value.

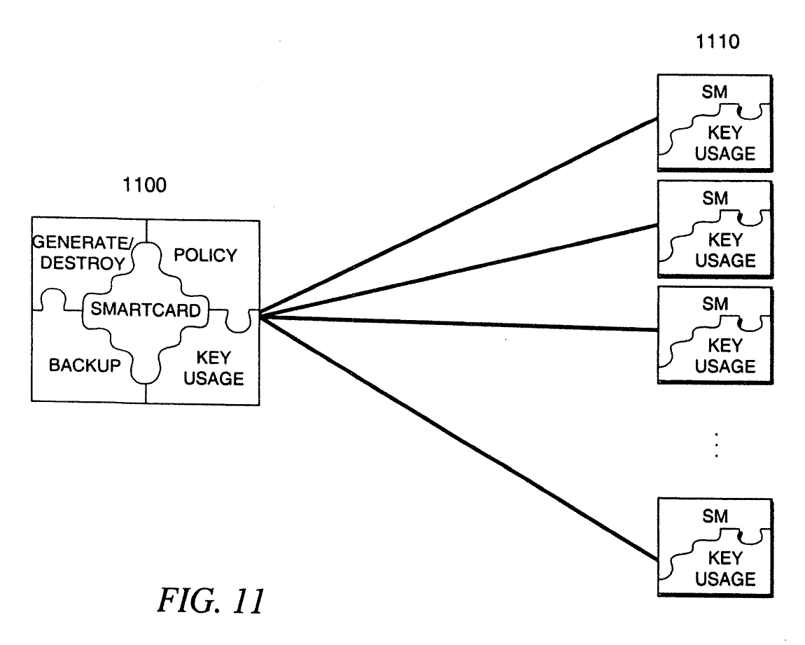

Referring now to FIG. 11, an embodiment of a key management system that incorporates stateless key management modules (hereafter referred to as stateless modules or SMs for convenience) is illustrated. In FIG. 11, smartcard 1100 (e.g., a hardware security module or a SIM) is configured to manage multiple remote stateless modules (or SMs) 1110.

Stateless modules may provide key enforcement and/or usage functions that are, in effect, separated out from the main key management functions provided by a smartcard. For example, a smartcard may provide all of the services for secure key management such as generating and destroying keys, establishing and enforcing key policy, using keys, providing key backup and secure key storage and communicating with peers. Inherently, these operations require that the smartcard keep track of its current state. For example, the smartcard must keep track of all keys it generated and it must maintain state information associated with each of these keys. This information may be used, for example, to determine the entity to which each key was issued and when to destroy or revoke keys. In contrast, the stateless modules provide a mechanism for securely receiving keys and using keys. The stateless modules do not generate keys or conduct peer-to-peer communication. Consequently, they typically must communicate with a key manager to obtain the keys needed by a mobile client (e.g., a mobile phone device, a PDA, etc.).

A stateless module does not need to maintain state information to receive keys and use keys. When a stateless module boots up, the only key information it has is an identity key that was stored in nonvolatile memory. However, this information is stateless because it never changes. To perform its tasks, the stateless module may be configured to establish a secure connection with a smartcard using its identity key. This secure connection enables the stateless module to perform the basic operations of receiving and using keys and/or data. These operations do not, however, require that the stateless module maintain the state of these keys. Rather, the stateless module merely needs to use the keys within a secure boundary and enforce any policy received with the key. As an example, after the smartcard securely sends keys to the stateless module these keys may be used to decrypt data and/or keys for a mobile client (e.g., a mobile phone device, a PDA, etc.). In addition, the stateless module may send secured (e.g., encrypted and/or authenticated) data to a designated device via a secure connection.

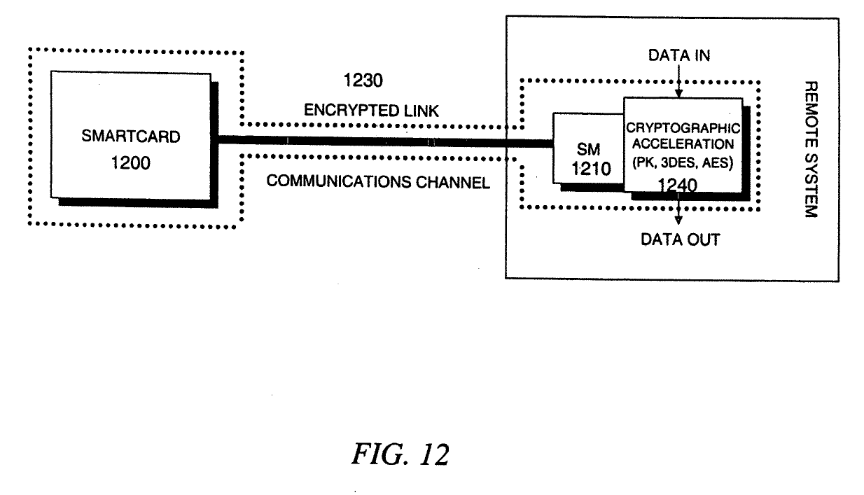

The stateless module provides a secure usage environment that may be remotely separated from, yet cryptographically secured to (e.g., using operations that may include encryption, decryption, authentication, etc.), the smartcard. In particular, keys and data within the stateless module are protected by hardware (e.g., the physical constraints provided by the integrated circuit, aka chip). In addition, the stateless module may be configured to prevent the keys and data from being exported from the chip without encryption (or in the clear). Moreover, as illustrated in FIG. 12, a key transfer protocol may be established between stateless module 1210 and smartcard 1200 to allow keys generated in smartcard 1200 to be securely transferred to stateless module 1210.

As is shown in FIG. 12 (and discussed above), encrypted link (communication channel) 1230 may be used to effectively extend the security boundary of smartcard 1200 to include the stateless module 1210. Encrypted link 1230 allows for key material to be transferred over an insecure communication medium (i.e. network and/or Internet) between smartcard 1200 and stateless module 1210.

FIG. 12 also illustrates that stateless module 1210 may receive encrypted key material from smartcard 1200 for use with local cryptographic accelerator 1240. Cryptographic accelerator 1240 also may be implemented within the effective security boundary. For example, cryptographic accelerator 1240 and stateless module 1210 may be implemented on the same integrated circuit. Alternatively, keys and data transferred between these components may be encrypted.

Thus, cleartext and ciphertext may be sent to cryptographic accelerator 1240 without exposing the key material outside of the security boundary. As a result, any key material that is decrypted locally by stateless module 1210 may never be exposed outside the security boundary.

Typically, a stateless module is embedded inside a mobile client that uses cryptographic services. For example, the stateless module may be implemented in mobile clients or end-user devices, such as cell phones, laptops, etc., that need some form of data security. The stateless module should be integrated into other chips (e.g., a main processor) within these devices. In this way, the stateless module may provide cost effective remote key management for a mobile client (e.g., a mobile phone device, a PDA, etc.). The security boundary to this mobile client is contained and managed through the stateless module by the smartcard key management system with minimal impact on the rest of the mobile client.

To support the above described key management scheme (i.e., to provide a high level of security at a relatively low cost, while consuming a relatively small amount of space on a mobile client), a stateless module provides mechanisms for securely loading one or more keys into the stateless module, securely storing the keys and securely using the keys. Embodiments of exemplary stateless modules that provide such mechanisms are provided in copending patent application Ser. No. 60/615,290, entitled Stateless Hardware Security Module, filed on Oct. 1, 2004, and assigned to the assignee of the present application, the entire content of which is incorporated herein by reference.

While certain exemplary embodiments have been described in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. For example, a system using SIM cards and GSM mobile network has been illustrated, but it should be apparent that the inventive concepts described above would be equally applicable to systems that use other types of smartcards and/or other types of mobile network. In view of the above it will be understood that the invention is not limited to the particular embodiments or arrangements disclosed, but is rather intended to cover any changes, adaptations or modifications which are within the scope and spirit of the invention as defined by the appended claims and equivalents thereof.

What is claimed is:

1. A communication network architecture for authenticating a user, the network architecture comprising:
a mobile network;
a mobile terminal;
a server coupled to the mobile terminal via the mobile network; and
a smartcard coupled to the mobile terminal, the smartcard having a first key and a second key;
wherein the first key authenticates an intended user of the mobile terminal to the mobile network; and
wherein the second key authenticates the intended user to the server.

2. The network architecture of claim 1, wherein the mobile network includes a copy of the first key to authenticate the intended user to the mobile network and wherein the server includes a copy of the second key to authenticate the intended user to the server.

3. The network architecture of claim 2, further comprising a second network coupled between the mobile network and the server.

4. The network architecture of claim 1, wherein the smartcard includes a third key to authenticate the intended user to a specific service offered by the server.

5. The network architecture of claim 1, wherein the smartcard includes a third key for encrypting and decrypting data transmitted between the mobile terminal and the mobile network.

6. The network architecture of claim 1, wherein the server comprises a data server and an authentication server and wherein the authentication server includes a copy of the second key to authenticate the intended user to the data server.

7. The network architecture of claim 6, wherein the mobile network includes a copy of the first key to authenticate the intended user to the mobile network and wherein the authentication server is not included within the mobile network.

8. The network architecture of claim 7, further comprising a second network coupled between the mobile network and the authentication server.

9. The network architecture of claim 8, wherein the second key is wirelessly revoked by the authentication server via the mobile network.

10. The network architecture of claim 6, wherein the authentication server includes a third key to revoke the second key.

11. The network architecture of claim 6, further comprising a second network and a key writing site coupled to the authentication server via the second network, wherein the key writing site is used to write the second key into the smartcard at a time when the intended user desires to receive a service from the data server and wherein the second key is provided from the authentication server to the key writing site.

12. The network architecture of claim 1, further comprising a key writing site, wherein the key writing site is used to write the second key into the smartcard at a time when the intended user has purchased a service from the server.

13. The network architecture of claim 1, wherein at least one of the first and second keys comprises a private key and a public key and wherein only a copy of the public key is available outside the smartcard to authenticate the intended user.

14. The network architecture of claim 1, wherein the smartcard comprises a subscriber identity module (SIM) card.

15. The network architecture of claim 1, further comprising a stateless module coupled to the smartcard and for securely receiving and using keys.

16. The network architecture of claim 15, wherein the stateless module provides a secure usage environment for receiving and using keys that is remotely separated from and cryptographically secured to the smartcard.

17. A method of authenticating a user through a communication network, the method comprising:
transmitting a first random number from within a mobile network to a mobile client;
using a first key in the mobile client to compute a first response based on the transmitted first random number;
transmitting the first response to the mobile network;
using a copy of the first key in the mobile network to calculate a first value based on the first random number;
determining whether the first response agrees with the first value;
terminating access of the mobile client to the mobile network if the first response does not agree with the first value;
transmitting a second random number from a server to the mobile client if the first response agrees with the first value;
using a second key in the mobile client to compute a second response based on the transmitted second random number;
transmitting the second response to the server;
using a copy of the second key in the server to calculate a second value based on the second random number;
determining whether the second response agrees with the second value;
terminating access of the mobile client to the server if the second response does not agree with the second value; and
granting access of the mobile client to the server if the second response agrees with the second value.

18. The method of claim 17, wherein the transmitting the second random number to the mobile client comprises transmitting the second random number from the server through a second network to the mobile client.

19. The method of claim 17, further comprising:
transmitting a third random number from the server to the mobile client if the second response agrees with the second value;
using a third key in the mobile client to compute a third response based on the transmitted third random number;
transmitting the third response to the server;
using a copy of the third key in the server to calculate a third value based on the third random number;
determining whether the third response agrees with the third value;
terminating access of the mobile client to a service offered by the server if the third response does not agree with the third value; and
granting access of the mobile client to utilize the service offered by the server if the third response agrees with the third value.

20. The method of claim 19, wherein the server comprises a data server and an authentication server, wherein the data server offers the service to the mobile client, and wherein the authentication server includes the copy of the second and third keys and grants access of the mobile client to the data server and to utilize the service offered by the data server.

21. The method of claim 17, wherein the using the copy of the second key in the server to calculate a second value based on the second random number comprises identifying the copy of the second key from a plurality of copies of other keys stored in the server.

22. The method of claim 17, further comprising:
receiving a subsequent message associated with a service offered by the server;
encrypting a service offered by the server to the mobile client;
identifying a third key stored in the mobile client and associated with the service; and
using the third key to decrypt the service offered by the server.

23. The method of claim 17, further comprising:
receiving a subsequent message from the server;
identifying a third key stored in the mobile client and associated with the subsequent message; and
using the third key to encrypt and decrypt data transmitted between the mobile client and the server.

24. The method of claim 17, wherein the first and second keys are stored within a subscriber identity module (SIM) card of the mobile client.

25. The method of claim 17, wherein the first and second keys are stored within a smartcard coupled to a stateless module for securely receiving and using keys.

26. The method of claim 25, wherein the stateless module provides a secure usage environment for receiving and using keys that is remotely separated from and cryptographically secured to the smartcard.

27. A communication network architecture for authenticating a user, the network architecture comprising:
a mobile network;
a mobile terminal;
a server coupled to the mobile terminal via the mobile network, the server providing a plurality of services; and
a smartcard coupled to the mobile terminal, the smartcard having a first key and a second key;
wherein the first key authenticates an intended user of the mobile terminal to the mobile network; and
wherein the second key authenticates the intended user to a service of the plurality of services provided by the server.

28. The network architecture of claim 27, further comprising a second network coupled between the mobile network and the server.

29. The network architecture of claim 27, wherein the smartcard includes a third key for encrypting and decrypting data transmitted between the mobile terminal and the service provided by the server.

30. The network architecture of claim 27, wherein the server comprises a data server and an authentication server, wherein the data server provides the plurality of services, and wherein the authentication server includes a copy of the second key to authenticate the intended user to the service provided by the data server.

31. The network architecture of claim 30, wherein the mobile network includes a copy of the first key to authenticate the intended user to the mobile network and wherein the authentication server is not included within the mobile network.

32. The network architecture of claim 31, further comprising a second network coupled between the mobile network and the authentication server.

33. The network architecture of claim 30, further comprising a second network and a key writing site coupled to the authentication server via the second network, wherein the key writing site is used to write the second key into the smartcard at a time when the intended user desires to receive the service from the data server and wherein the second key is provided from the authentication server to the key writing site.

34. The network architecture of claim 27, further comprising a key writing site, wherein the key writing site is used to write the second key into the smartcard at a time when the intended user purchases the service provided by the server.

35. The network architecture of claim 27, wherein the smartcard comprises a subscriber identity module (SIM) card.

36. The network architecture of claim 27, further comprising a stateless module coupled to the smartcard and for securely receiving and using keys.

37. The network architecture of claim 36, wherein the stateless module provides a secure usage environment for receiving and using keys that is remotely separated from and cryptographically secured to the smartcard.
